(19) United States
(12) Patent Application Publication
(10) Pub. No.: US 2017/0301037 A1
(43) Pub. Date: Oct. 19, 2017

(54) GROUP DISCOURSE ARCHITECTURE

(71) Applicant: International Business Machines Corporation, Armonk, NY (US)

(72) Inventors: Aaron K. Baughman, Silver Spring, MD (US); Thomas D. Erickson, Minneapolis, MN (US); Brian P. Gaucher, Brookfield, CT (US); Wendy A. Kellogg, Solana Beach, CA (US)

(21) Appl. No.: 15/132,492

(22) Filed: Apr. 19, 2016

(51) Int. Cl. G06Q 50/00; G06Q 10/10

(52) U.S. Cl. CPC G06Q 50/01; G06Q 10/10

(57) ABSTRACT

For a given time period, for each pair of a plurality of participants in a meeting, it is determined whether a connection exists between members of the pair. For the given time period, for each pair of the participants for which a connection exists, a valence of the connection is determined; a social network is created, depicting the connections and their valences; and, based on the social network, at least one faction is identified within the plurality of participants in the meeting. The steps of determining the connections, determining the valences, creating the network, and identifying the at least one faction, are repeated for a plurality of additional time periods, to assess faction dynamics of the plurality of participants in the meeting.

### FIELD OF THE INVENTION

The present invention relates to the electrical, electronic, and computer arts, and, more particularly, to cognitive and contextual computing, and the like.

### BACKGROUND OF THE INVENTION

The study of group dynamics can be useful in understanding decision-making behavior. When people interact and communicate in a face-to-face manner, a person can, for example, detect the emotions of another person through observation of physical gestures, eye movements, facial expressions, and the like. It may be more difficult to obtain such feedback in a group environment.

### SUMMARY OF THE INVENTION

Principles of the invention provide techniques for group discourse architecture; in particular, techniques to determine and track who is interacting with whom, and the social consequences of that interaction. In one aspect, an exemplary method includes the step of, for a given time period, for each pair of a plurality of participants in a meeting, determining whether a connection exists between members of the pair. Further steps include, for the given time period, for each pair of the participants for which a connection exists, determining a valence of the connection; for the given time period, creating a social network depicting the connections and their valences; for the given time period, based on the social network, identifying at least one faction within the plurality of participants in the meeting; and repeating the steps of determining the connections, determining the valences, creating the network, and identifying the at least one faction, for a plurality of additional time periods, to assess faction dynamics of the plurality of participants in the meeting.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects, as will be appreciated by the skilled artisan from the disclosure herein.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a flow chart of a method, in accordance with an aspect of the invention;

FIG. 2 shows a block diagram, in accordance with another aspect of the invention;

FIG. 3 depicts an example of positive faction dynamics, ascertained in accordance with an aspect of the invention;

FIG. 4 depicts a computer system that may be useful in implementing one or more aspects and/or elements of the invention;

FIG. 5 presents a table showing exemplary evidence for a connection from person X to person Y; and

FIG. 6 shows exemplary interactional spaces, as known from the prior art.

### DETAILED DESCRIPTION OF PREFERRED EMBODIMENTS

One or more embodiments provide a method and system for automatically detecting and tracking interactional patterns during a meeting as a method of assessing group dynamics, such as faction formation and dissolution, shunning and alienation, dispute and disruption, and so on. Interaction patterns of interest include gaze dynamics (who is looking at whom, when), gesture and posture dynamics, speech volume, turn-taking, maintenance (or not) of interpersonal distance, and interactional synchrony. Specifically, in one or more embodiments a discourse architecture monitoring software module assesses, tracks, and monitors person-to-person and person-environment interaction using video, audio and gesture recognition, and represents such interaction using graph and tree topologies.

As used herein, the following definitions apply:
Group=the entire set of people under consideration
Faction (equivalently, subgroup or coalition)=one or more members of the Group who are allied with one another, and who are distinct from one or more other members of the Group; Factions may shift over time
Group Faction Architecture=the way in which members of the Group are associated with one another in Factions
Group Faction Architecture Dynamics=the shift in the structure of the Group Faction Architecture over time

One or more embodiments automatically and probabilistically detect and track human interactional patterns to assess group discourse architecture. In contrast, known solutions include individual cognitive bias measures, group anchor bias measures, and pre- and/or post-surveys. In one or more embodiments, as key meeting points are reached or as decision making is taking place, an exemplary system utilizes video-, audio-, and gestural-based sensors to detect factions in a group, either collocated in a room and/or present through device interfaces. As part of an overall system, group discourse architecture predicts and/or substantiates whether a key meeting point, decision or vote should take place and/or calculates the number of factions that exist in the room and if the faction has support or lacks attention. The detection of factions within a larger group is also used in one or more embodiments to guide the initiation of activities aimed at reducing factionalization (if the group is too divided) or increasing factionalization (if the group has failed to sufficiently explore the landscape of alternative positions).

Advantageously, one or more embodiments provide group interaction detection using video, human signatures (skin luminescence, eye gaze, eye dilation, etc.), interactional synchrony, environment cues (showing positive image and negative image including who looks at what); combine all evidence to produce features based on positive faction dynamics, negative faction dynamics, dissolution, shunning, alienation, and/or disputes; and/or build a positive tree model from evidence features.

In one or more exemplary embodiments, a room is equipped with several sensor systems such as video, audio and gesture (e.g., wand, glove, and video gesture recognition systems). Throughout the course of a meeting or interaction of two or more people, a video system monitors individuals and tracks their head and eye movements and pupil dilation to assess who they are looking at and if they are looking favorably or unfavorably at that person or persons. Similarly, audio systems track conversation through recognition and transcription and use this to assist in correlation of head and/or eye tracking to determine if factions are forming or breaking. As gestural sensors such as wands, gloves and video gesture recognition systems become more pervasive, these gestural sensors can also be incorporated into the decision process regarding who may or may not be forming into a faction. For example, arms crossed and pupils narrowed of a first person as his or her gaze is fixed on one or more other people may indicate dissent and lack of group cohesion. Crossing of arms is treated as a pertinent gesture in one or more embodiments. Indeed, where an individual stands, whether personal space is violated, body language indicating that a first person does not get along with and/or believe a second person, and the like can all be significant in one or more embodiments.

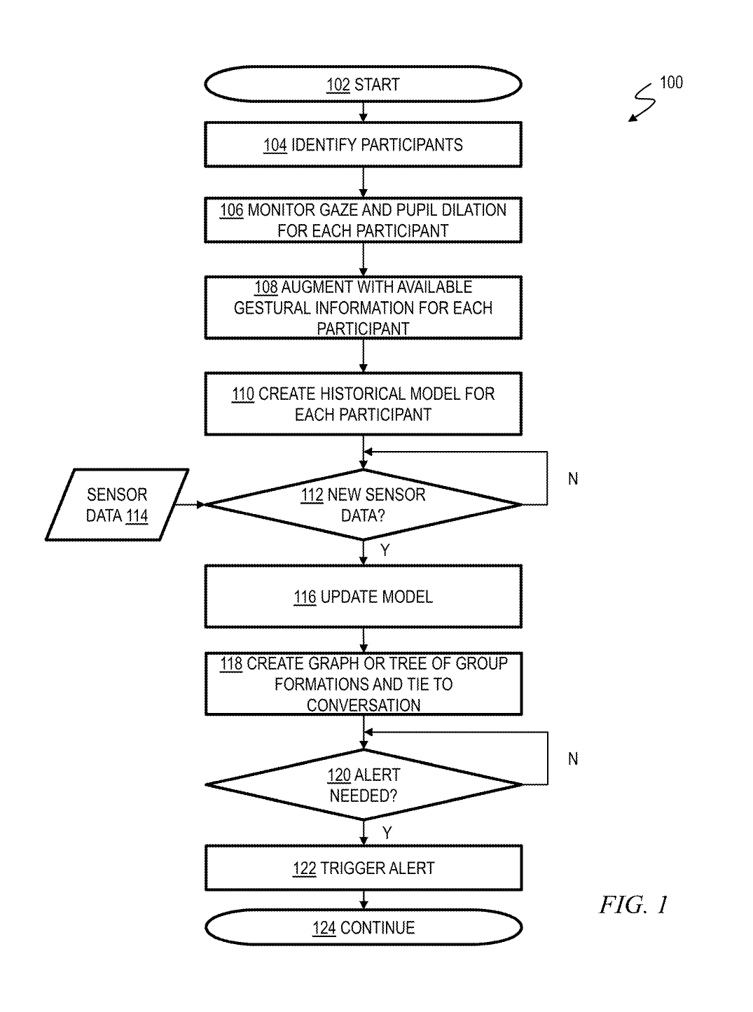

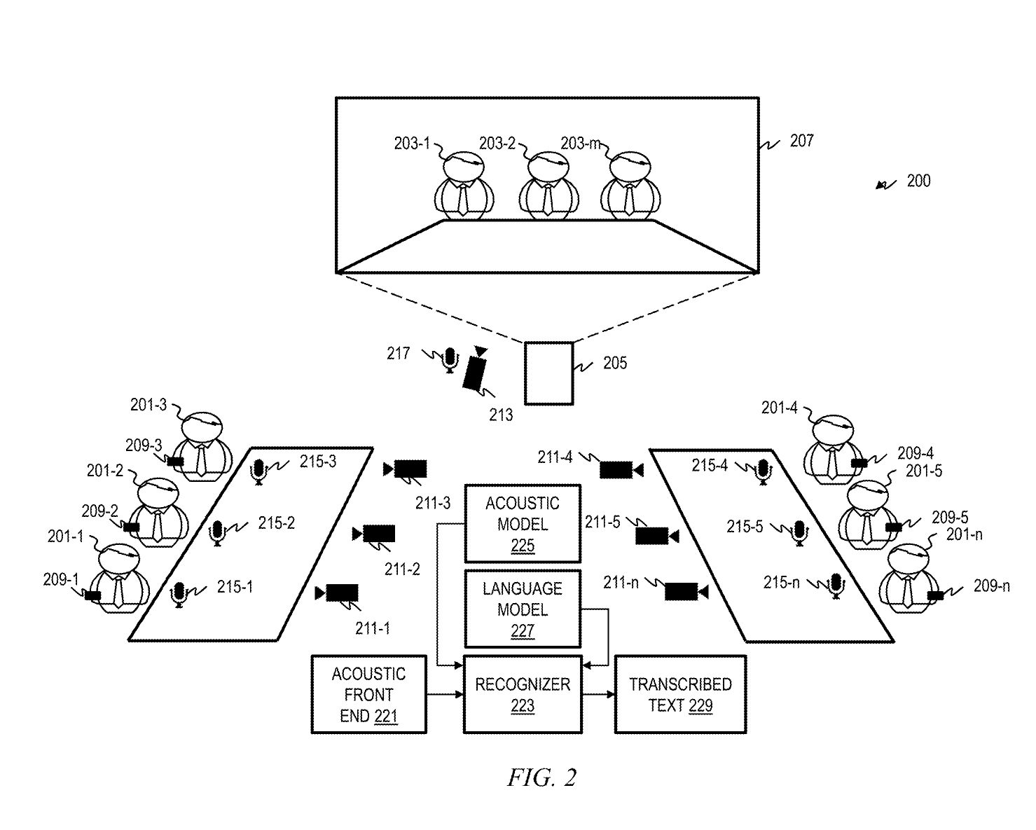

FIG. 1 shows a flow chart of a method, in accordance with an aspect of the invention, and FIG. 2 shows a block diagram, in accordance with an aspect of the invention, of an exemplary system for carrying out the method of FIG. 1. In FIG. 2, n meeting participants 201-1, 201-2, 201-3, 201-4, 201-5 . . . 201-n (collectively 201) are present within a meeting room 200. Some embodiments include a projection display formed by projector 205 and screen 207, on which m remote meeting participants 203-1, 203-2 . . . 203-m (collectively 203) appear. Other types of displays could be used if desired. One or more of the meeting participants can be provided with wearable sensing devices 209-1, 209-2, 209-3, 209-4, 209-5 . . . 209-n (collectively 209). While n devices are shown corresponding to n participants, the number of devices and participants need not necessarily be the same; some or all participants may not have any devices; some or all participants may have more than one device. In a non-limiting example, each of the n participants can have an associated video camera 211-1, 211-2, 211-3, 211-4, 211-5 . . . 211-n (collectively 211). While n cameras are shown corresponding to the n participants, the number of cameras and participants need not necessarily be the same; anywhere from one camera to n−1 cameras can be provided in alternative embodiments—where there is less than one camera for each participant, the camera(s) may tilt and/or pan as needed to cycle back and forth among the participants, or a lens with a suitably wide angle can be employed so that one camera can view more than one participant. One or more video cameras 213 can also be provided to view screen 207 so as to analyze the gestures, gaze, behavior, and the like of remote meeting participants 203-1, 203-2 . . . 203-m.

One or more embodiments also include a plurality of audio based sensors 215-1, 215-2, 215-3, 215-4, 215-5 . . . 215-n (collectively 215) (e.g., microphones). While n audio sensors are shown corresponding to the n participants, the number of audio sensors and participants need not necessarily be the same; anywhere from one audio sensor to n−1 audio sensors can be provided in alternative embodiments—where there is less than one audio sensor for each participant, speaker recognition can be employed to determine which of the participants is speaking. Furthermore in this regard, if every person is wearing a microphone then it is possible to simply identify who is using what microphone, and to then track which microphones signals are coming from, thus permitting identification of speakers. If more than one person is using a microphone, then to identify a speaker that person's voice should be recognized (i.e. map particular vocal characteristics to an individual person) which is also known as speaker recognition. One or more audio sensors 217 can also be provided and oriented towards screen 207 (assuming that loudspeakers are located adjacent screen 207) so as to analyze the speech of remote meeting participants 203-1, 203-2 . . . 203-m. The loudspeakers associated with screen 207 may be part of same or separate, and are omitted from the drawing to avoid clutter.

In other instances, the remote video and/or audio feed could be analyzed directly rather than having cameras view the screen and rather than having microphones pick up sounds from the associated loudspeakers.

Wearable sensing devices 209-1, 209-2, 209-3, 209-4, 209-5 . . . 209-n can include, by way of example and not limitation, gesture based sensors such as wands or gloves. In addition or alternatively, gesture recognition software can be employed to analyze video from the video cameras 211-1, 211-2, 211-3, 211-4, 211-5 . . . 211-n. In another aspect, wearable sensing devices 209-1, 209-2, 209-3, 209-4, 209-5 . . . 209-n could include galvanic skin response (GSR) sensors to measure the electrical conductivity of the skin as indicative of emotional and/or cognitive states.

In some embodiments, cameras 211-1, 211-2, 211-3, 211-4, 211-5 . . . 211-n are capable of hyperspectral imaging; for example, to detect skin luminescence of meeting participants 201-1, 201-2, 201-3, 201-4, 201-5 . . . 201-n.

Thus, eye-related aspects such as pupil dilation and direction of gaze; speech; and movement can be sensed in a room through, e.g., one or more simple video cameras (optionally with associated microphones). Motion can be detected and other more complex sensors can be employed if desired.

Some embodiments identify participants via speech recognition and transcription, using, e.g., a speech recognition system including microphones 215 and/or 217; acoustic front end 221, and recognizer 223 employing acoustic model 225 and language model 227. The speech recognition system outputs transcribed text 229 and can be implemented on a computer 412 or the like. Cabling from the microphones 215, 217 to the acoustic front end 221 is omitted to avoid clutter. Speech recognition includes recognition and translation of spoken language into text by computers and computerized devices; speaker recognition is the identification of a person from characteristics of voices, and is discussed above.

Note that software portions of the speech recognition elements shown in FIG. 2 may be implemented, for example, as software modules of a data processing system 412 discussed below, which when loaded into memory configure the processor of such a system to implement appropriate functionality. Other modules can be included but are omitted from FIG. 2 to avoid clutter; e.g., modules to implement models of people, environmental models, graph formation, threshold comparison, gesture recognition software, and the like.

Referring also now to flow chart 100 of FIG. 1, which begins at 102, in step 104, identify each person or participant in a meeting through video, speaker recognition (discussed above), and/or speech recognition systems (“I am John Smith”; “I am Jane Doe”). Of course, appropriate privacy protections should be implemented; for example, an opt-in/opt-out procedure can be put in place and/or results can be anonymized. In a case where meeting participants are collocated, audio, video, or a combination of video and audio can be employed to reduce ambiguity. Some embodiments track people, once identified, as they move around within a room. In a case with remote meeting participants, if the participants have dialed in, the number they call from will be known and they can self-identify; it will be known what connection they are using. Speech or facial recognition can also be used in the remote case, if remote participants are talking or connected by video, respectively.

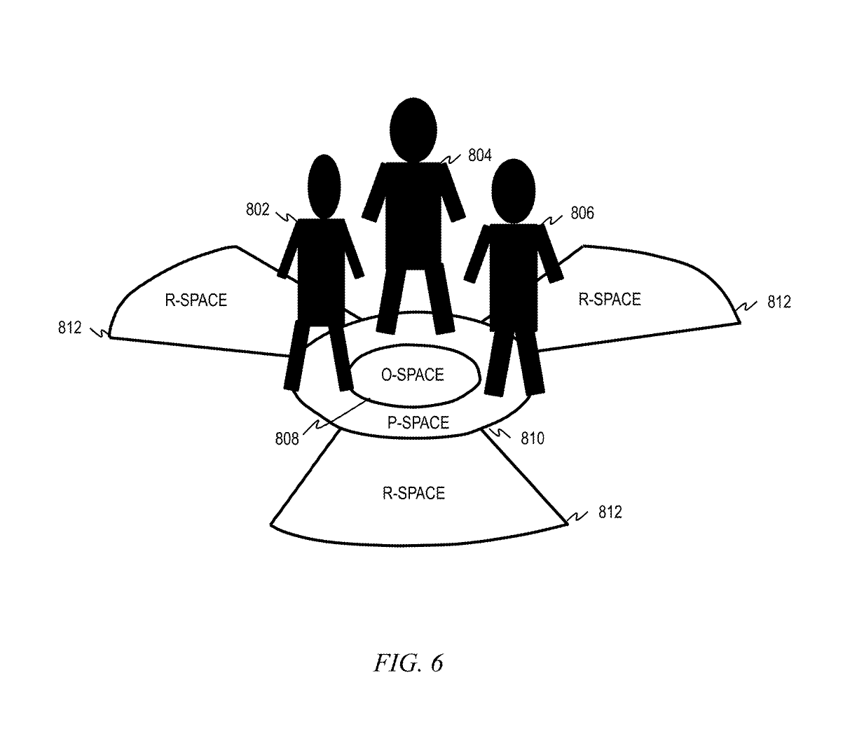

In step 106, monitor each participant's gaze to detect which person or persons it is directed at and monitor the person's pupil dilation to detect whether and to what extent it is occurring. Gaze and pupil dilation can be alternatives, but can also be used together, inasmuch as the gaze direction provides evidence about what the pupil dilation is in response to. Additional or alternative measures include interactional distance, bodily orientation (e.g. face to face), position relative to the group (e.g., r-space, p-space—see discussion of FIG. 6), and the like. In step 108, optionally augment that information with any gestural information either from wands or gloves worn or though video systems that can detect such body language as arms crossed or open, hands clenched or open, and so on. Note that interpersonal distance and interactional synchrony can take the place of and/or augment other parameters. Interactional synchrony can be taken as evidence for agreement/positive connections. Moving from a normal interpersonal distance to a greater distance can be taken as disagreement, and so on. In step 110, optionally create a historical model representative of each participant. Then, continually update the model(s) (if utilized) with sensor information—for example, if decision block 112 indicates new sensor data 114 is available, update the model(s) in step 116; else, continue to await new data. In step 118, create a graph or tree of faction formations over the course of the meeting and tie these factions to conversation via transcription. For example, the speech recognition system creates the transcripts and text mining and/or data mining can be employed to determine the topics of transcribed speech. In steps 120 and 122, trigger alerts as needed; e.g., thresholds indicate faction formation is taking place or breaking up as tied to specific topics. In particular, alerts are triggered in step 122 if decision block 120 indicates an alert is needed based on the aforementioned threshold criteria or the like. Processing continues in step 124.

A distinction should be made between members of a faction (i.e. set of people in agreement), and a set of people in proximity. A faction may well separate and talk with other people in the group—either unallied individuals or other factions—and they may indeed go to other rooms to do this. In some instances, the system tracks and assesses these interactions, and detects who they are occurring with and whether they are positive or not. In a ‘healthy’ interaction, it might be seen that a faction member persuades someone not of that faction to adopt their position—here it would be expected to see evidence for an interaction between two people, with gradually increasing positive valence in that interaction.

In one or more embodiments, a variety of techniques can be used to establish connections, e.g., based on facial orientation, gaze, expression, gestures, speech, proximity, and the like. At least some embodiments employ cameras and software that can map a human face and determine the orientation of the face in general and the orientation of the eyes in particular (for example, the iris and pupil appear circular when viewed head on but elliptical when viewed from an angle; the eccentricity of the ellipse can be used to detect the angle). Expression recognition can be helpful in some instances. Pupil size is pertinent in some instances, and can be determined from a camera image. Some embodiments detect instantaneous pupil dilations due to emotion.

One or more embodiments consider gesture recognition, directed speech, and/or proximity. Gesture recognition to implement one or more embodiments can be carried out using known techniques, given the teachings herein. Refer, for example, to Richard A. Bolt, “Put-That-There”: Voice and Gesture at the Graphics Interface, Architecture Machine Group, Massachusetts Institute of Technology, Cambridge, Mass. 02139 USA, ©1980 ACM 0-89791-021-4/80/0700-262, pages 262-270, 1980, expressly incorporated herein by reference in its entirety for all purposes. Proximity and approach can be detected with image processing software. Active badges can be employed in some instances (e.g., RFID).

Non-visible physiological responses are measured in some cases. For example, in some instances, monitor for heart rate, (can be determined via imaging the veins on the subject's head, for example). In some instances, back channeling or private chatting can be treated as the analog of directed speech—this is believed to be particularly beneficial in remote cases. Similarly, if interaction is by remote camera and the operator zooms in on a person or group, this action is the analog of facial orientation and/or gaze.

Furthermore regarding private chatting or instant messaging, in some cases, an application programming interface (API) can be provided to the chat software, or in some instances, chat capability is part of a meeting system in use, e.g., refer to the system described in Xianghua Ding et al., “An Empirical Study of the Use of Visually Enhanced VoIP Audio Conferencing: The Case of IEAC,” CHI 2007, April 28-May 3, 2007, San Jose, Calif. USA, hereby expressly incorporated herein by reference in its entirety for all purposes. Suitable systems can include a visual interactive proxy, to which access is available. If generic chat software outside the corporate firewall is to be employed, suitable additional code can be developed by the skilled artisan to capture the chat content.

Pertinent data may be available in the remote case, in at least some instances, based on a controlled camera in the room and/or a visual interface to the meeting, such as via the SKYPE service available from Microsoft Corporation, Redmond, Wash., USA. The position of a remote person can be monitored—for example, if he or she leaves his or her desk, this indicates a potential lack of interest.

It is worth noting that perfect accuracy in interpreting the sensors is typically neither possible nor necessary.

In one or more embodiments, in the remote case, a screen 207 shows the remote person 203 locally in the room as a presence. Other cameras 213 may be viewing the image. Thus, one or more embodiments treat the remote person's video image as a person—some loss of accuracy may be expected due to double video encoding. The case of a remote person present in a meeting via audio from a loudspeaker can be handled in an analogous way (e.g. via microphone 217).

In one or more embodiments, the network is created and the factions are identified using social network analysis, based on one or more suitable measures of connectedness. Given the teachings herein, the skilled artisan will be able to select one or more connectedness measures and adapt known techniques of social network analysis to implement one or more embodiments. Over time, a cognitive system may be able to make larger or alternative group dynamic inferences from different networks, looking at different measures in combination. Typically, in a social network, the nodes are people and the edges are relationships between people; the edges include a strength and sometimes a type. In some cases, ask each person in a network to rate their relationships with every other person (each individual may or may not know other people); then use the parallelized ratings to construct the network. Thus, in one or more embodiments, one or more networks are constructed based on one or more connection metrics.

In one or more embodiments, to identify one or more factions, look for positive connections between persons in a putative faction and negative connections with individuals outside the putative faction, using social network analysis. Some embodiments consider centrality measures; “clumps” connected through a single person who acts as a bridge. For example, in a negotiation, each side may have an executive with a group of minions. Initially, each side may form a group with little or no connection between the groups; however, as time goes on, if the negotiations are amicable, people in different groups may form friendships and connections may develop.

Some embodiments allow people to manually enter their moods. This will assist in developing feedback about the nature of the meeting. Some embodiments allow people to raise issues as they go along based on conscious feedback (e.g. people are tired let's take a break) or even to explain away actions (e.g., “no, I am very interested in what you say, I just got distracted by X”).

One or more embodiments thus provide a method and system for detecting participant interaction through video, audio, and/or gestural sensor systems. In some embodiments, a further step includes creating group graphs and trees that tie transcribed conversation to faction formation in real-time. Besides gaze and gesture, there are at least two other behavioral metrics that can be tracked:
interpersonal distance (including bodily orientation); and
interactional synchrony.

Interpersonal distance has to do with how far apart people choose to stand from one another. As anthropologist Edward Hall has noted, “Social distance between people is reliably correlated with physical distance,” so observing how far apart to people choose to be provides a behavioral measure of their degree of social connection. One or more embodiments detect when two or more members of a group are interacting with one another, and the characteristics of that interaction, i.e., positive or negative. One way to detect a positive interaction is to note that two or more individuals will stand in proximity to one another; if they are in proximity a lot, this may denote a positive bond or alliance. The disbanding of a proximate group provides evidence that the interaction is ceasing; it may or may not indicate that an alliance is disbanding, but that could be taken as one bit of evidence in favor of that hypothesis.

Comfortable interpersonal distances vary, and so one cross-cultural dysfunction that can occur is that in the case of two people from different cultures who are in conversation, one may keep advancing on the other (to maintain his or her comfortable distance), while the second retreats (for the same reason). The first experiences the second as ‘standoffish’ or unfriendly; the second experiences the first as ‘pushy.’ One or more embodiments provide a system that notices this dynamic and is helpful in alerting participants to the dynamic, thus facilitating defusing the misunderstandings that are likely to occur.

More generally, in one or more embodiments, the positional and orientational patterns of multi-person groups can be tracked over time and used to analyze interactions. Regarding the tracking aspect, reference is made to Adam Kendon's concept of F-Formations, as described, for example, in “Using F-formations to analyse spatial patterns of interaction in physical environments,” Paul Marshall, Yvonne Rogers, and Nadia Pantidi, CSCW '11, Proceedings of the ACM 2011 conference on Computer supported cooperative work, pp 445-454, hereby expressly incorporated herein by reference in its entirety for all purposes. As discussed above, one or more embodiments are concerned with detecting interactions among two or more individuals. Noting not just proximity but how people are oriented towards one another—e.g. face to face, side by side—provides evidence for connections and/or valence thereof. As before, if these orientations persist or recur over time, that provides evidence for a positive bond or alliance.

Furthermore, “Interactional Synchrony” has been studied since the 1970s; the term appears to have been introduced by William S. Condon. Refer, for example, to “It's all in the timing: Interpersonal synchrony increases affiliation,” Michael J. Hove and Jane L. Risen, Social Cognition, Vol. 27, No. 6, 2009, pp. 949-961, hereby expressly incorporated herein by reference in its entirety for all purposes. Thus, people who are interacting, and in particular, people who are in agreement, tend to unconsciously (1) mirror one another's postures (e.g., if I fold my arms, you are more likely to), and (2) move in rhythm with one another at sub second intervals. Being able to detect either mirroring or micromovement synchrony provides evidence for (positive) interaction.

In brief, people in conversation unconsciously rhythmically synchronize their body movements (from eye movements to finger taps), and, speaking broadly, the achievement of synchronization among two conversation participants is correlated with increased liking and comprehension. For instance, an article from the American Psychological Association suggests that people are less likely to synchronize overall recurrent body movements—a valid measure of bodily synchrony—during an argument than during a friendly chat.

One or more embodiments advantageously build not just a model of the people, but also provide a model of the environment, including:
displays and/or I/O surfaces/spaces (e.g., so it can be determined when people have their gazes directed to a display), and
interactional spaces (e.g., what Kendon calls the “O space”—the space in the middle of a group of people (and also the P and R spaces)), so it can be determined when a group ‘makes room’ for a new member to join. As shown in FIG. 6, people 802, 804, 806 who form a small group in physical space are said to define three regions: O space 808 which is empty so that communicants can see one another and receive visual feedback, P space 810 where they position their bodies, and R space 812, where people who wish to be invited to join the interaction will come. People in R-space are visible in the peripheral vision of the group, but not part of the interaction. Someone moving from R-space to P-space is (very likely) being invited into the interaction (or, unlikely but possible, being pushy and disruptive), whereas someone who hovers in R-space without moving into P-space is (very likely) being snubbed, ignored, or is a low status person being tolerated. All of this tells us about group membership and dynamics.

Thus, it will be appreciated that conversation is not just about what people say and where they look, it is also about where they position and move their bodies in relation to one another, and to the artifacts in the environment that they are using as conversational props.

Consider the following equation:

$${P}_{p 1 , p 2} ( PT \vert {E}_{ℊ} , {E}_{d} , {V}_{a} , {S}_{a} ) = \frac{P ( {E}_{ℊ} \vert PT ) P ( {E}_{d} \vert PT ) P ( {V}_{a} \vert PT ) P ( {S}_{a} \vert PT ) P ( PT )}{P ( {E}_{ℊ} , {E}_{d} , {V}_{a} , {S}_{a} )}$$

where:

p₁=team player 1

p₂=team player 2

PT=positive team interactions

E_{g}=positive eye gaze annotations

E_{d}=positive eye dilation annotations

Vₐ=positive video annotations

Sₐ=positive speech annotations.

The above equation is a maximum likelihood on several likelihoods.

It is desired to know the probability that a pair of players, factions, etc. are having positive interactions given eye gaze, eye dilation, video annotations and speech annotations. Note that the evidence for positive interactions is not limited to the asserted features. This provides a Bayesian grounding to measure the probability that people are interacting well together given biometric signals (knowledge, cognitive, behavioral and physiological).

This leads to the next decision tree. Given the measurements from the equation, obtain a number of different probabilities over time that people are having positive interactions. Take each pairing and create categories. These categories are used to branch the tree using the Gini growth (or any other one) to build teams at the terminals.

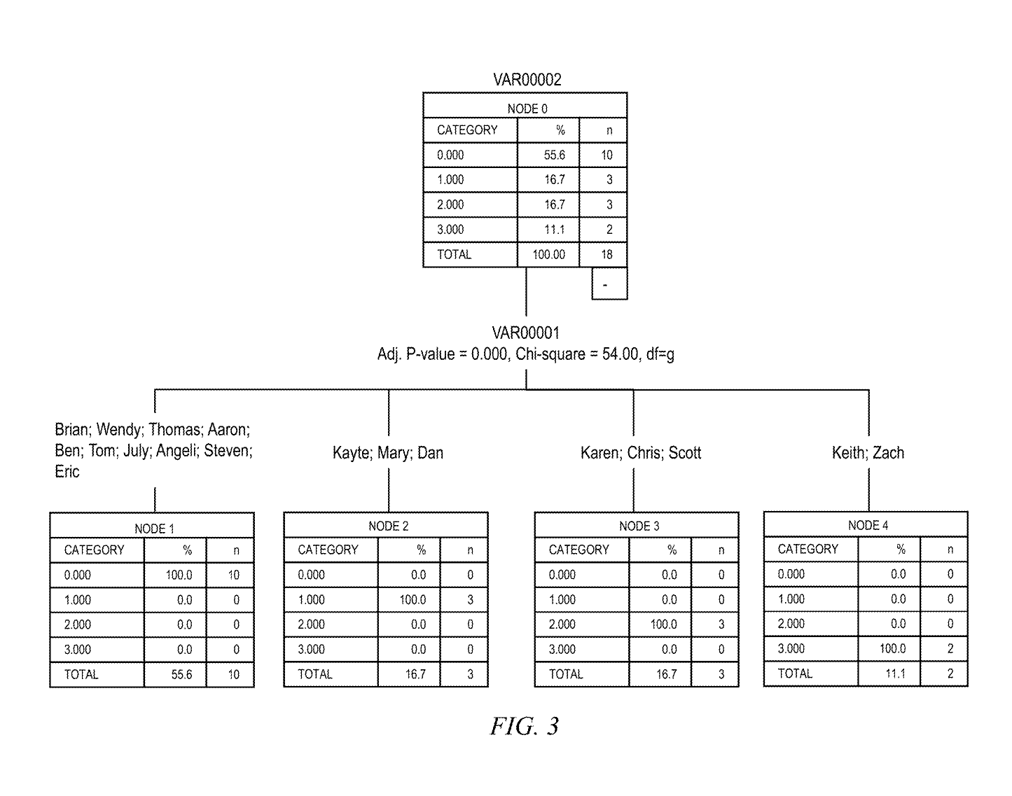

In this way, use the output of the equation to measure the different combinations of positive interactions for people and then bin them to teams with the decision tree. FIG. 3 shows a non-limiting exemplary decision tree.

In one or more embodiments, a tree topology is created for each member's state that is to be monitored—this is a multi-class problem. Each set of tree rules is created during a training phase. Both random forests (selection of n features whereby the best predictive feature is selected on a purity measure at each branch since this is treated as a classification problem). The terminal nodes are a composition of members and their type of interaction. i.e. bored, positive, negative. A person can be in more than one faction because feature vectors are produced in combination with other faction members. For example, if a feature about “Brian” has eye gaze as “intense” and skin luminescence “high” while he is talking with “Thomas,” the feature vector will be indexed with “Thomas.” “Brian” will be most likely classified as excited and the index of the feature vector will build up the team in the terminal node. If, for the “Brian” tree, “Thomas” is found within the bored and excited terminals, the most frequent times “Thomas” is present within bored or excited wins. If the states tie, a breadth measure that counts the number of unique topics discussed within a meeting is the tie breaker. If there is still a tie, then create an optimistic tree where “Thomas” will be placed within the excited node.

It is worth noting that while cohort determination per se is well known in the art, one or more embodiments use cognitive indicators to determine profile in relation to other cognitive indicators from other users; this allows construction of an interaction graph for further cohort analysis.

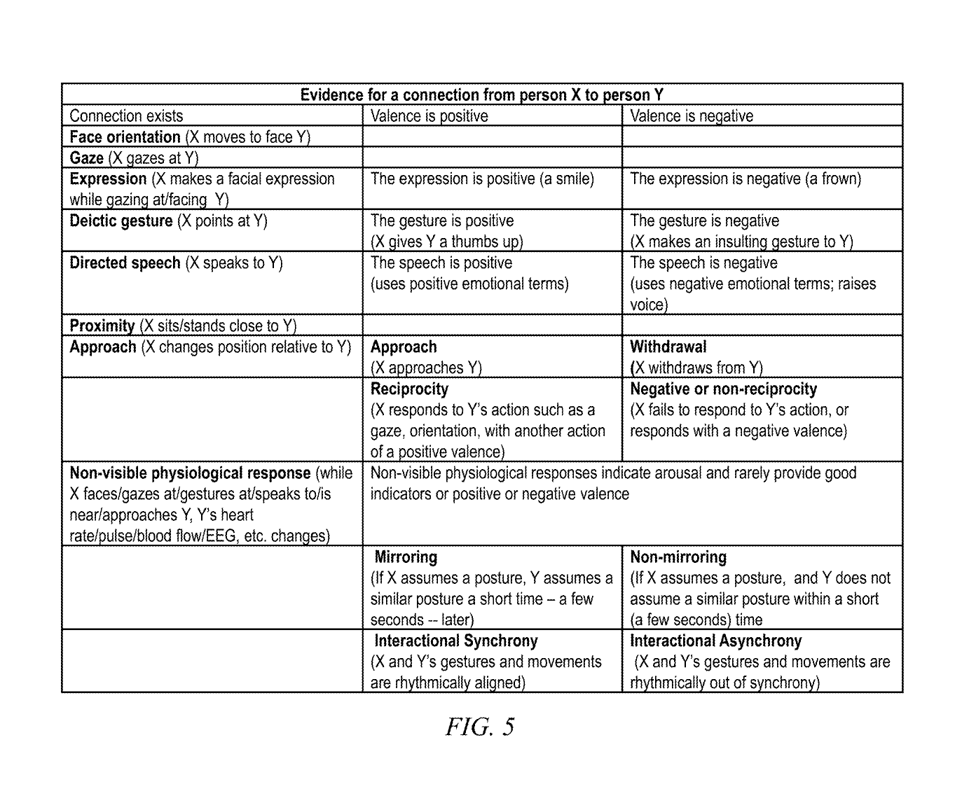

One or more embodiments provide a method and system for automatically detecting and tracking interactional patterns during a meeting as a technique for assessing group dynamics. Group dynamics include faction formation and dissolution, shunning and alienation, dispute and disruption, and so on. More particularly, one or more embodiments include identifying each person or participant in a meeting through video or speech recognition systems; monitoring each participant's pupil dilation and gaze and who the gaze is directed at; augmenting information about pupil dilation and the subject of the gaze with any gestural information either from wands or gloves worn or though video systems that can detect such body language as arms crossed, or open, hands clenched or open etc.; creating a historical model representative of each participant and continually updating it with sensor information; creating a graph or tree of group formations over the course of the meeting and tying these groups to conversation via transcription; and triggering alerts as needed e.g. thresholds indicate group formation is taking place or breaking up as tied to specific topics. It will be appreciated by the skilled artisan, given the teachings herein, that pupil dilation is evidence of interest; gaze is evidence of attention, and may be either positive or negative. Furthermore, more generally, for each possible pair of persons in the group, one or more embodiments maintain hypotheses about (1) whether the persons are interacting, and (2) whether that interaction is positive or negative. Many sources of data can be used to increase or decrease confidence about those hypotheses, as discussed elsewhere herein and depicted in the table of FIG. 5.

Note that one or more embodiments use “projection” to refer to a projection display as opposed to using it in the mathematical sense of projecting something from one mathematical space into another. Furthermore, one or more embodiments use “group” to refer to human social groups and “behavior” to refer to the actions of human individuals, particularly in relation to one another, as opposed to using the term “group” to refer to multiple data points, and the term “behavior” to refer to how characteristics of those data points change over time.

Even further, one or more embodiments involve detecting and tracking the behaviors of individual humans in relation to one another (e.g., gazing, gesturing, bodily postures). One or more embodiments employ a projection display for detecting and tracking the configuration of human groups (and other dynamic properties that reflect their social relationships and interactions). One or more embodiments make inferences about the formation and dynamics of human groups based on the interaction of individual humans; some of this inference can be based on the tracking and movement of individual humans relative to on another.

It is important to recognize that in a group or subgroup, the ways in which humans respond to one another (or fail to respond to one another) are very strong indicators of the group's degree of cohesion, and of the dynamically shifting relationships within the group or subgroup. The sort of indicators referred to are behavioral responses that are reflected in gaze, gesture, posture, proximity, tone of voice, and other indicators described later. Note that these behavioral responses are an innate aspect of how humans establish and regulate their social bonds with one another, and are a fundamental aspect of human functioning.

As an example, consider a group of five people interacting over a period of ten seconds.

In one case, a single person may be speaking and gesturing, stretching out his hands as he speaks to the group and shifting his gaze from one to another. The four other members all gaze attentively at him, some nodding as he speaks to indicate their agreement. Everyone's posture is relaxed, and after the speaker ends his statement with a joke, the members of the group chuckle or smile. This is an example of a group that is in accord, managing to communicate effectively and maintaining a good emotional tenor within the group.

To continue the example, imagine another ten seconds of interaction occurring in the same group ten minutes later. One person is speaking loudly, jabbing a finger repeatedly at a second member. The second member's gaze is downcast, and her arms are crossed in front of her body. Two other members of the group are looking at one another, not at the speaker, and carrying on a simultaneous conversation; they have pushed their chairs a bit back from the table. The fifth member of the group has tried to interrupt the speaker several times, and is standing up with hands on hips, glaring at the speaker; the speaker has not acknowledged the fifth member, or made eye contact with him. This is an instance of a group experiencing discordant communication as indicated by gaze, gesture, posture, proximity and tone of voice; from these cues it can be inferred that three members are involved in a dispute and are unhappy with one another, that the two other members have withdrawn and are communicating with one another, and that perhaps this group is about to split into two or more factions.

It is important to note that the second state of the group is not necessarily a dysfunctional one. Disagreement and argument is a natural part of group interaction, and it is one of the processes through which groups think through problems, develop solutions, and reach agreement. Ideally, groups work through disagreements and reach a resolution; sometimes, though, discordant interactions may be severe enough to damage the social relationships among group members and make reaching a resolution difficult or impossible. In either event, one or more embodiments allow these group dynamics and their impact on the group's interaction and social structure to be tracked.

FIG. 5 presents a table summarizing exemplary evidence for a connection from person X to person Y. In one or more embodiments, for a pair of people (X and Y) in a space (physically such as 201-1 and 201-5 or virtually such as 201-1 and 203-2), determine the connection from X to Y and from Y to X, and assess the connection's valence (whether positive or negative) for time period T. This process is repeated for all possible pairs in the room (physically or virtually) for time T. Then, create a network showing the degree and valence of connections among all people in the room. Identify factions within the group. Factions tend to have positive connections among members, and negative connections to non-members. The four steps of (i) determining connection and assessing valence, (ii) repeating (i) for the rest of the pairs, (iii) creating the network, and (iv) identifying the factions are repeated over many time periods during the course of a meeting or event, and the dynamics of the group's factions are determined, including:
whether the group is coalescing into one faction or fragmenting into many factions;
whether faction memberships are constant or whether they are shifting;
whether the valence of interactions within and between is increasing or decreasing in strength.

Thus, in one or more embodiments, begin with a pair of people, X and Y, in a space (physically or virtually). It is desired to determine the connection from X to Y. Identify participants, and, for each participant, monitor gaze and/or pupil dilation (it is beneficial to monitor both but not necessary). While some embodiments are limited to physically collocated people, other embodiments encompass both collocated and spatially diverse people. One or more embodiments look for connections or who is paying attention to whom. In some instances, feelings and intents can be derived—determine whether factions are being formed, whether alliances are being formed, and so on. The ultimate goal in one or more instances is to take a group having a meeting and be able to say that there are multiple factions in the group; those in a faction feel positively towards one another, but may have positive or negative relations to other factions. The first column of the table of FIG. 5 lists different methods of determining whether two people are connected; i.e., one is paying attention to the other. The second two columns address whether the attention is positive or negative (hostile, rude, or ignoring).

The skilled artisan will appreciate that there is a term in psychology called emotional valence which can be generally positive or negative; in essence, a behavioral or attitudinal temperature—the valence terminology is being used in this standard way herein.

Thus, in one or more embodiments, some meeting participants, who may or may not be collocated, have been identified, and an examination is being made for connections between each pair of people. One or more embodiments examine pair-by-pair for each pair and determine whether there is a connection for those two people. Examining all the pairs will lead to sub-groups with more than two people. Examining for connections can be carried out, by way of example and not limitation, via gaze or pupil dilation. In one or more embodiments, next, augment with gestural information, as part of forming the connections. Optionally, create a historical model, and update the model as new sensor information is obtained, and then create a graph or a tree.

Furthermore regarding historical modelling, consider a network where each node is a human and each node potentially has values to indicate whether the person for that node is facing another node in the network, gazing at another node in the network, making expressions, and whether all of those interactions are positive or negative. In one or more embodiments, the historical model unfolds dynamically in real time. In essence, the historical model is a time series that becomes significant as it can be seen how things (e.g., people's alliances and/or groups) change with time; advantageously, one or more embodiments provide insights as to why this is happening.

It should be noted that historical models are optional, and in some embodiments, a network is constructed based on cognitive interaction metrics, without use of a detailed historical model. Inferences can be made about connections and whether they are positive or negative based only on interactions sensed during the course of the gathering. Some embodiments implement a learning system; i.e., a cognitive system whose performance improves over time. For example, the system remembers observations and aggregates results from meetings and individuals. Thus, some embodiments employ a network without a historical model, while other embodiments add a historical model for enhanced capabilities.

Some embodiments employ a simple historical model; for example, stored metrics for individuals and different meetings. In this regard, measure air time for each person and remember same, and over time, obtain a distribution of how much someone usually talks per unit of meeting time. The system can tell if someone is talking more or less than usual. Some embodiments also address smiling or other cultural factors (some cultures nod even if they do not agree; other cultures nod to show agreement). Other measures include the amount of time between turns speaking; whether someone jumps in or waits to see if the speaker is finished.

One or more embodiments will give due consideration to the cooperative principle, which describes how people interact with one another, and was developed by Paul Grice. The cooperative principle includes the four Gricean Maxims (quality, quantity, relevance, and manner).

In one or more embodiments, the system can learn over time how better to interpret the sensed data by remembering, and coming to see what is normative for, individuals, factions, and groups.

Thus, some embodiments include a low fidelity base network, while others include a higher fidelity network including historical models that can be based, e.g., on stored metrics (air time, smiling, cultural factors such as nodding, turn taking, and the like).

Some embodiments store historical data on how someone has typically approached meetings in the past, and set a flag if that person “goes outside the box”; inferences can be drawn from such behavior. This approach can also be extended to subgroups or entire meetings.

In a non-limiting example, one or more embodiments include four aspects:
1. What can be sensed about people and their behavior—more than mere pupil dilation and eye gaze, e.g., air time, content of speech, tone of speech, and so on
2. What interpretations can be made of things sensed under point 1—e.g., positive or negative valence
3. What actions are to be taken by the cognitive system, once some conclusion(s) have been reached? For example, models of individuals may be employed in one or more embodiments. A cognitive system monitoring a plurality of meetings can be provided with a generic prototype to compare the dynamics of meetings against. One or more embodiments start out with generic prototypes of groups, and then the prototype models are specialized based on knowledge of particular groups that meet and/or of particular individuals over time.
4. Some embodiments assess the quality of the meeting so that the system obtains feedback and is able to provide recommendations or reflections back to people to improve the dynamics of the meeting. For example, a simple light can indicate decline in attention span, excessive disagreement, or faction creation—such an indication can be provided gently to the host or even to the entire room. Offline feedback to individuals or faction leaders may also be appropriate in some instances.

Thus, it will be appreciated that while some embodiments are limited to sensing and interpretation (e.g., regarding connections and group dynamics), other embodiments address a larger picture including, e.g., corrective action and/or quality feedback.

By way of review and provision of additional detail, one or more embodiments are concerned with:
1. Who is interacting with whom (i.e., is person A paying attention/speaking/listening to person B)?
2. Is the interaction valence positive or negative (i.e., does person A agree with/feel positively towards person B)?

For each possible pair of persons in the group, one or more embodiments (ideally) employ multiple sources of evidence to support or reject the above (referred to as hypotheses):

To determine if person A is interacting with person B, consider:
1. Is A facing in B's direction?
2. Is A gazing at B?
3. Is A in proximity to B?
4. If A is speaking, is it likely B can hear A?
5. Are A and B conversing with one another?
6. Is A verbally indicating agreement with B?

If an interaction is occurring, look for further evidence of whether that interaction is positive or negative:
1. Have A's pupil's dilated?
2. Is A smiling or frowning?
3. Is A nodding or shaking his or her head?
4. Has A raised his or her voice?
5. Has A crossed his or her arms?
6. Is A within normal interpersonal distance of B, and/or has A approached B more closely (conversely, is A outside the normal interpersonal distance of B or is A increasing that distance?)
7. Is A exhibiting interaction synchrony with B? (Alternatively, is A out of synchrony with B?)
8. Are A and B taking turns as they converse with one another (Alternatively, are A and B interrupting or talking over one another?)

Reference is again made to FIG. 5.

By tracking these and other similar types of evidence over time it is possible to:
a. identify factions of the group whose members are in mutual agreement and in disagreement with other factions, and
b. determine how this changes over time.

Thus, one or more embodiments:
1. Detect the ‘social architecture’ of a group's discourse and track it over time, being aware of:
   situations in which factions never form (i.e. everyone is in agreement from the start) because that may indicate “group think” and/or that the group has not done a good job of considering multiple possibilities
   situations in which factions have hardened—i.e. factions have become emotionally involved in their positions and are refusing to budge.
2. When poor discourse architecture trajectories occur, take action to “nudge” the group towards more productive behavior:
   e.g., encouraging the formation of temporary factions to explore different positions when the group's discourse has been too harmonious
   e.g., encouraging activities that decrease factionalization (e.g., time-outs, coffee breaks, topic changes, trust-building exercises) when factions appear to have hardened.

Given the discussion thus far, it will be appreciated that, in general terms, an exemplary method, according to an aspect of the invention, includes the step of, for a given time period, for each pair of a plurality of participants 201 and/or 203 in a meeting, determining whether a connection exists between members of the pair (see, e.g., first column of FIG. 5). Further steps include, for the given time period, for each pair of the participants for which a connection exists, determining a valence of the connection (see, e.g., second and third columns of FIG. 5); for the given time period, creating a social network depicting the connections and their valences (see, e.g., step 118); and, for the given time period, based on the social network, identifying at least one faction within the plurality of participants in the meeting (see, e.g., FIG. 3 and accompanying text). The steps of determining the connections, determining the valences, creating the network, and identifying the at least one faction, are repeated for a plurality of additional time periods, to assess faction dynamics of the plurality of participants in the meeting. Note that “creating” the network, in this context, includes creation ab initio and/or updating an existing network, effectively creating a new one.

In some instances, determining whether the connection exists comprises examining for at least one of facial orientation, gaze, expression, deictic gesture, directed speech, proximity, change of position, electronic messaging, and non-visible physiological response.

In a non-limiting example, the valence is determined to be positive when the expression is positive, the deictic gesture is positive, the directed speech is positive, the change of position comprises approach, a first participant of a given pair of participants positively responds to an action by a second participant of the given pair of participants, the first participant of the given pair of participants mirrors a posture assumed by the second participant of the given pair of participants, and/or interactional synchrony is observed between the first participant of the given pair of participants and the second participant of the given pair of participants.

In a non-limiting example, the valence is determined to be negative when the expression is negative, the deictic gesture is negative, the directed speech is negative, the change of position comprises withdrawal, a first participant of a given pair of participants negatively responds to an action by a second participant of the given pair of participants, the first participant of the given pair of participants fails to respond to the action by the second participant of the given pair of participants, the first participant of the given pair of participants fails to mirror a posture assumed by the second participant of the given pair of participants, and/or interactional asynchrony is observed between the first participant of the given pair of participants and the second participant of the given pair of participants.

In some cases, in the identifying step, the participants are collocated; in other instances, in the identifying step, at least one of the participants is remote.

Some embodiments further include generating an intervention flag of even an actual intervention when the faction dynamics appear poor. An intervention flag is a warning to, e.g., a meeting leader or the like, that faction dynamics appear poor, optionally with a diagnosis as o the nature of the problem and/or a suggested intervention. The actual intervention could, as discussed above, include encouraging the formation of temporary factions to explore different positions when the group's discourse has been too harmonious, or encouraging activities that decrease factionalization (e.g., time-outs, coffee breaks, topic changes, trust-building exercises) when factions appear to have hardened.

The skilled artisan will be familiar with video analysis of individuals to determine direction of gaze. In known techniques of pupil tracking, the image analysis determines the shape of the pupil from the direction of the camera, and the pupil changes apparent shape based on the relative positioning of the eye and camera (e.g., circular when straight on, oval when viewed from an angle). Pupil diameter to estimate dilation can also be measured during this process.

One or more embodiments of the invention, or elements thereof, can be implemented, at least in part, in the form of an apparatus including a memory and at least one processor that is coupled to the memory and operative to perform exemplary method steps.

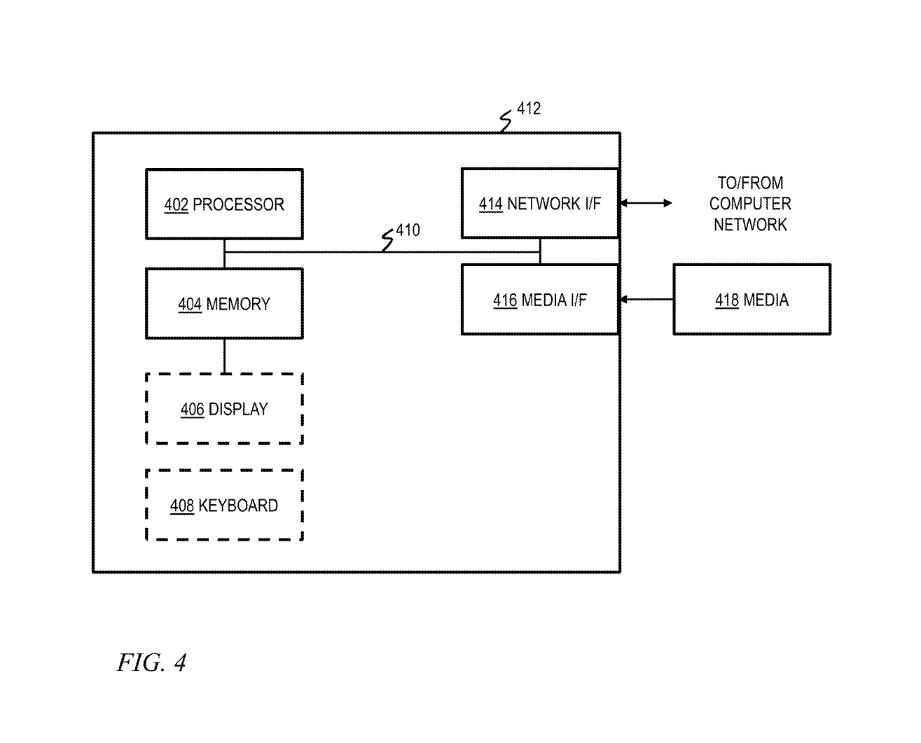

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418. Network interface 414 is also representative of suitable interfaces to acquire signals and/or data (e.g., from cameras 211, 213 and/or microphones 215, 217). Other interfaces could be used for such acquisition as well; e.g., analog-to-digital converters and the like.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a di splay and keyboard.

It should be noted that any of the methods described herein can include an additional step of providing a system comprising distinct software modules embodied on a computer readable storage medium (e.g., persistent storage portion of memory 404); the modules can include, for example, any or all of the elements depicted in the block diagrams or other figures and/or described herein. For example, the modules could include a user interface module (e.g., HTML code served out by a server to a browser of a client) and a group discourse architecture monitoring software module. As noted above, software portions of the speech recognition elements shown in FIG. 2 may be implemented, for example, as software modules. Other modules can include modules to implement models of people, environmental models, graph formation, threshold comparison, gesture recognition software, and the like. The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising the steps of:
for a given time period, for each pair of a plurality of participants in a meeting, determining whether a connection exists between members of said pair;
for said given time period, for each pair of said participants for which a connection exists, determining a valence of said connection;
for said given time period, creating a social network depicting said connections and their valences;
for said given time period, based on said social network, identifying at least one faction within said plurality of participants in said meeting; and
repeating said steps of determining said connections, determining said valences, creating said network, and identifying said at least one faction, for a plurality of additional time periods, to assess faction dynamics of said plurality of participants in said meeting.

2. The method of claim 1, wherein said determining whether said connection exists comprises examining for at least one of facial orientation, gaze, expression, deictic gesture, directed speech, proximity, change of position, electronic messaging, and non-visible physiological response.

3. The method of claim 2, wherein said valence is determined to be positive when at least one of:
said expression is positive;
said deictic gesture is positive;
said directed speech is positive;
said change of position comprises approach;
a first participant of a given pair of participants positively responds to an action by a second participant of said given pair of participants;
said first participant of said given pair of participants mirrors a posture assumed by said second participant of said given pair of participants; and
interactional synchrony is observed between said first participant of said given pair of participants and said second participant of said given pair of participants.

4. The method of claim 2, wherein said valence is determined to be negative when at least one of:
said expression is negative;
said deictic gesture is negative;
said directed speech is negative;
said change of position comprises withdrawal;
a first participant of a given pair of participants negatively responds to an action by a second participant of said given pair of participants;
said first participant of said given pair of participants fails to respond to said action by said second participant of said given pair of participants;
said first participant of said given pair of participants fails to mirror a posture assumed by said second participant of said given pair of participants; and
interactional asynchrony is observed between said first participant of said given pair of participants and said second participant of said given pair of participants.

5. The method of claim 1, wherein, in said identifying step, said participants are collocated.

6. The method of claim 1, wherein, in said identifying step, at least one of said participants is remote.

7. The method of claim 1, further comprising generating an intervention when said faction dynamics appear poor.

8. A non-transitory computer readable medium comprising computer executable instructions which when executed by a computer cause the computer to perform the method of:
for a given time period, for each pair of a plurality of participants in a meeting, determining whether a connection exists between members of said pair;
for said given time period, for each pair of said participants for which a connection exists, determining a valence of said connection;
for said given time period, creating a social network depicting said connections and their valences;
for said given time period, based on said social network, identifying at least one faction within said plurality of participants in said meeting; and
repeating said steps of determining said connections, determining said valences, creating said network, and identifying said at least one faction, for a plurality of additional time periods, to assess faction dynamics of said plurality of participants in said meeting.

9. The non-transitory computer readable medium of claim 8, wherein said determining whether said connection exists comprises examining for at least one of facial orientation, gaze, expression, deictic gesture, directed speech, proximity, change of position, electronic messaging, and non-visible physiological response.

10. The non-transitory computer readable medium of claim 9, wherein said valence is determined to be positive when at least one of:
said expression is positive;
said deictic gesture is positive;
said directed speech is positive;
said change of position comprises approach;
a first participant of a given pair of participants positively responds to an action by a second participant of said given pair of participants;
said first participant of said given pair of participants mirrors a posture assumed by said second participant of said given pair of participants; and
interactional synchrony is observed between said first participant of said given pair of participants and said second participant of said given pair of participants.

11. The non-transitory computer readable medium of claim 9, wherein said valence is determined to be negative when at least one of:
said expression is negative;
said deictic gesture is negative;
said directed speech is negative;
said change of position comprises withdrawal;
a first participant of a given pair of participants negatively responds to an action by a second participant of said given pair of participants;
said first participant of said given pair of participants fails to respond to said action by said second participant of said given pair of participants;
said first participant of said given pair of participants fails to mirror a posture assumed by said second participant of said given pair of participants; and
interactional asynchrony is observed between said first participant of said given pair of participants and said second participant of said given pair of participants.

12. The non-transitory computer readable medium of claim 8, wherein, in said identifying step of said method, said participants are collocated.

13. The non-transitory computer readable medium of claim 8, wherein, in said identifying step of said method, at least one of said participants is remote.

14. The non-transitory computer readable medium of claim 8, wherein said computer executable instructions, when executed by said computer, further cause the computer to perform the additional method step of generating an intervention flag when said faction dynamics appear poor.

15. An apparatus comprising:
a memory; and
at least one processor, coupled to said memory, and operative to:
for a given time period, for each pair of a plurality of participants in a meeting, determine whether a connection exists between members of said pair;
for said given time period, for each pair of said participants for which a connection exists, determine a valence of said connection;
for said given time period, create a social network depicting said connections and their valences;
for said given time period, based on said social network, identify at least one faction within said plurality of participants in said meeting; and
repeat said determining of said connections, said determining of said valences, said creating of said network, and said identifying of said at least one faction, for a plurality of additional time periods, to assess faction dynamics of said plurality of participants in said meeting.

16. The apparatus of claim 15, wherein said at least one processor determines whether said connection exists by examining for at least one of facial orientation, gaze, expression, deictic gesture, directed speech, proximity, change of position, electronic messaging, and non-visible physiological response.

17. The apparatus of claim 16, wherein said at least one processor determines said valence to be positive when at least one of:
said expression is positive;
said deictic gesture is positive;
said directed speech is positive;
said change of position comprises approach;
a first participant of a given pair of participants positively responds to an action by a second participant of said given pair of participants;
said first participant of said given pair of participants mirrors a posture assumed by said second participant of said given pair of participants; and
interactional synchrony is observed between said first participant of said given pair of participants and said second participant of said given pair of participants.

18. The apparatus of claim 16, wherein said at least one processor determines said valence to be negative when at least one of:
said expression is negative;
said deictic gesture is negative;
said directed speech is negative;
said change of position comprises withdrawal;
a first participant of a given pair of participants negatively responds to an action by a second participant of said given pair of participants;
said first participant of said given pair of participants fails to respond to said action by said second participant of said given pair of participants;
said first participant of said given pair of participants fails to mirror a posture assumed by said second participant of said given pair of participants; and
interactional asynchrony is observed between said first participant of said given pair of participants and said second participant of said given pair of participants.

19. The apparatus of claim 15, wherein said participants are collocated.

20. The apparatus of claim 15, wherein at least one of said participants is remote.
